(19) United States
(12) Patent Application Publication
(10) Pub. No.: US 2026/0342416 A1
(43) Pub. Date: Oct. 29, 2026

(54) INTER CELL BEAM MANAGEMENT

(71) Applicant: Nokia Technologies Oy, Espoo (FI)

(72) Inventors: Halit Murat GÜRSU, Munich (DE); Panagiotis SPAPIS, Munich (DE); Umur KARABULUT, Munich (DE); Amaanat ALI, Espoo (FI); Timo KOSKELA, Oulu (FI); Srinivasan SELVAGANAPATHY, Bangalore (IN); Subramanya CHANDRASHEKAR, Bangalore (IN); Ahmad AWADA, Munich (DE); Ali KARIMIDEHKORDI, Munich (DE)

(21) Appl. No.: 19/099,711

(22) PCT Filed: Jun. 23, 2023
(86) PCT No.: PCT/EP2023/067104

§ 371 Date: Jan. 29, 2025

(30) Foreign Application Priority Data
Jul. 29, 2022 (IN) 202241043490

(51) Int. Cl. H04B 7/06; H04W 36/00

(52) U.S. Cl. CPC H04B 7/06952; H04W 36/0072

(57) ABSTRACT

Methods and radio access network nodes for inter cell beam management, wherein a source distributed node and target distributed node are controlled by a central node of the radio access network. The central node determines to initiate an inter cell beam management procedure for a user equipment being served by the source distributed node and transmits a setup request towards the target distributed node to configure a beam of a cell of the target distributed node for the user equipment. The central node receives a setup response with user equipment specific beam management configuration information related to the requested beam of the cell of the target distributed node and transmit, towards the source distributed node, configuration information to enable the source distributed node to initiate an inter cell beam management operation with the user equipment.

### FIELD

The present disclosure generally relates to mobile communication networks such as a 5G communication network, and more particularly to promoting connectivity and service quality to mobile terminals.

### BACKGROUND

Wireless and mobile telecommunication systems are under constant development. There is a need for higher data rates and high quality of service. Reliability and service requirements rise, while reducing transmission delays and increasing throughput are further aims of mobile communication standard developments.

One particular aspect is service continuity. A user equipment (UE) moving through the network infrastructure of a mobile communication network with its radio access network faces varying radio conditions. To maintain an ongoing service and connectivity, a UE is handed-over to another base station or radio cell when moving away from the coverage area of its current base station or cell. However, the number of back-and-forth handovers, usually referred to as “ping pongs”, should be reduced as the execution of each handover procedure introduces signalling overhead.

### SUMMARY

According to a first aspect, an inter cell beam management method for a radio access network is provided. The radio access networks includes a source distributed node and a target distributed node. The source distributed node and target distributed node are controlled by a central node of the radio access network. The central node determines to initiate an inter cell beam management procedure for a user equipment being served by the source distributed node and transmits a setup request towards the target distributed node in order to configure a beam of a cell of the target distributed node for the user equipment. The central node receives a setup response from the target distributed node with user equipment specific beam management configuration information related to the requested beam of the cell of the target distributed node. The central node transmits at least a part of the configuration information towards the source distributed node to enable the source distributed node to initiate an inter cell beam management operation with the user equipment.

In some embodiments, the inter cell beam management operation comprises a low layer mobility procedure or a dynamic cell switching procedure.

In some embodiments, the setup request includes an inter-cell beam management indication and packet scheduling related information.

In some embodiments, the setup request includes an indication of a bandwidth part currently utilized by the user equipment and the setup response includes an indication that the beam of the cell of the target distributed node is to be configured on the first bandwidth part.

In some embodiments, the central node sends a context modification request, towards the source distributed node requesting inter cell beam management related information about the user equipment and receives a context modification response from the source distributed node indicating inter cell beam management related information about the user terminal which may indicate at least one of timing advance information of the user equipment, bandwidth part information of the user equipment, and a measurement configuration of the user equipment.

In some embodiments, the central node configures the user equipment to perform measurements at least of the beam of the cell of the target distributed node and receives at least one measurement report from the user equipment indicating results of the measurements of at least the beam of the cell of the target distributed node.

In some embodiments, the central node provides at least a part of the results of the measurements in the setup request to the target distributed node.

In some embodiments, the central node receives an indication from the source distributed node of a number of beams or identity of beams which are timing advance aligned with neighboring cells.

In some embodiments, the central node determines a bandwidth part switch for the user equipment changing the user equipment from a first bandwidth part to a second bandwidth part and transmits an indication of the bandwidth part switch for the user equipment towards the target distributed node. The central node then receives a confirmation from the target distributed node that the beam of the cell of the target distributed node is reconfigured in accordance with the bandwidth part switch for the user equipment, and reconfigures the user equipment to with the second bandwidth part.

In some embodiments, the central node receives an indication from the source distributed node to switch the first bandwidth part of the user equipment to the second bandwidth part. The central node may indicate to the source distributed node not to use the beam of the cell of the target distributed node. The central node transmits a modification request indicating the second bandwidth part towards the target distributed node and receives a modification response from the target distributed node confirming that the beam of the target distributed node is reconfigured to the second bandwidth part. The central node then indicates towards the source distributed node that the beam of the cell of the target distributed node is to be reconfigured to the second bandwidth part.

In some embodiments, the setup request indicates multiple bandwidth parts suitable for the communication of the user equipment with the source distributed node and the setup response indicates at least a subset of the multiple bandwidth parts which is suitable for the beam of the cell of the target distributed node, and the configuration information includes the subset of the multiple bandwidth parts to enable the user equipment to operate any bandwidth part of the subset of the multiple bandwidth parts on the beam of the cell of the target distributed node.

In some embodiments, the central node receives a confirmation from the source distributed node indicating successful configuration of the user equipment to operate on the beam of the target distributed node. The central node then causes, with the target distributed node, a bearer configuration to enable user data transmission over the beam of the target distributed node and forwards user data for the user equipment to the target distributed node.

According to a further aspect, an inter cell beam management method for a radio access network including a source distributed node and a target distributed node, the source distributed node and target distributed node being controlled by a central node of the radio access network. The source distributed node receives configuration information from the central node related to a beam of a cell of the target distributed node and initiates an inter cell beam management operation with the user equipment to enable the user equipment to operate on the beam of the cell of the target distributed node.

In some embodiments, the inter cell beam management operation comprises a low layer mobility procedure or a dynamic cell switching procedure.

In some embodiments, the configuration information includes an inter-cell beam management indication or packet scheduling related information.

In some embodiments, the configuration information indicates a bandwidth part currently used by the user equipment with the source distributed node to be used for the beam of the cell of the target distributed node.

In some embodiments, the source distributed node receives a context modification request from the central node requesting inter cell beam management related information about the user equipment and transmits a context modification response towards the central node indicating inter cell beam management related information about the user terminal which may indicate at least one of timing advance information of the user equipment, bandwidth part information of the user equipment, and a measurement configuration of the user equipment.

In some embodiments, the bandwidth part information of the user equipment indicates multiple bandwidth parts suitable for the communication of the user equipment with the source distributed node and wherein the configuration information includes at least a subset of the multiple bandwidth parts to enable the user equipment to operate any bandwidth part of the subset of the multiple bandwidth parts on the beam of the cell of the target distributed node.

In some embodiments, the source distributed node sends an indication towards the central node indicating a number of beams or identity of beams which are timing advance aligned with neighboring cells.

In some embodiments, the source distributed node sends an indication towards the central node to switch a first bandwidth part of the user equipment to a second bandwidth part. The source distributed node receives an indication from the central node not to use the beam of the target distributed node and that the beam of the target distributed node is to be reconfigured to the second bandwidth part and indicates the reconfiguration to the second bandwidth part to the user equipment.

In some embodiments, the source distributed node sends a confirmation towards the central node indicating successful configuration of the user equipment to operate on the beam of the target distributed node.

According to still a further aspect, a central node for inter cell beam management in a radio access network is provided, the radio access network comprises a source distributed node and a target distributed node. The source distributed node and target distributed node are controlled by the central node of the radio access network. The central node comprises at least one processor and at least one memory including computer program code causing the central node, when executed with the at least one processor, to determines to initiate an inter cell beam management procedure for a user equipment being served by the source distributed node and then to transmit a setup request towards the target distributed node to configure a beam of a cell of the target distributed node for the user equipment. The central node is further caused to receive a setup response from the target distributed node with user equipment specific beam management configuration information related to the requested beam of the cell of the target distributed node and to transmit at least a part of the configuration information towards the source distributed node to enable the source distributed node to initiate an inter cell beam management operation with the user equipment.

In some embodiments, the inter cell beam management operation comprises a low layer mobility procedure or a dynamic cell switching procedure.

In some embodiments, the setup request includes an inter-cell beam management indication or packet scheduling related information.

In some embodiments, the setup request includes an indication of a bandwidth part currently utilized by the user equipment and the setup response includes an indication that the beam of the target distributed node is to be configured on the first bandwidth part.

In some embodiments, the central node is further caused to send a context modification request towards the source distributed node requesting inter cell beam management related information about the user equipment and to receive a context modification response from the source distributed node indicating inter cell beam management related information about the user terminal which may indicate at least one of timing advance information of the user equipment, bandwidth part information of the user equipment, and a measurement configuration of the user equipment.

In some embodiments, the central node is further caused to configure the user equipment to perform measurements at least of the beam of the cell of the target distributed node and to receive at least one measurement report from the user equipment indicating results of the measurements of at least the beam of the cell of the target distributed node.

In some embodiments, the central node is further caused to provide at least a part of the results of the measurements in the setup request to the target distributed node.

In some embodiments, the central node is further caused to receive, from the source distributed node, an indication of a number of beams or identity of beams which are timing advance aligned with neighboring cells.

In some embodiments, the central node is further caused to determine a bandwidth part switch for the user equipment changing the user equipment from a first bandwidth part to a second bandwidth part, to transmit an indication of the bandwidth part switch for the user equipment towards the target distributed node, to receive a confirmation from the target distributed node that the beam of the cell of the target distributed node is reconfigured in accordance with the bandwidth part switch for the user equipment, and to reconfigure the user equipment with the second bandwidth part.

In some embodiments, the central node is further caused to receive an indication from the source distributed node to switch the first bandwidth part of the user equipment to the second bandwidth part, to indicate towards the source distributed node not to use the beam of the cell of the target distributed node, to transmit a modification request towards the target distributed node indicating the second bandwidth part, to receive a modification response from the target distributed node confirming that the beam of the target distributed node is reconfigured to the second bandwidth part, and to indicate towards the source distributed node that the beam of the cell of the target distributed node is to be reconfigured to the second bandwidth part.

In some embodiments, the setup request indicates multiple bandwidth parts suitable for the communication of the user equipment with the source distributed node and the setup response indicates at least a subset of the multiple bandwidth parts which is suitable for the beam of the cell of the target distributed node, and wherein the configuration information includes the subset of the multiple bandwidth parts to enable the user equipment to operate any bandwidth part of the subset of the multiple bandwidth parts on the beam of the cell of the target distributed node.

In some embodiments, the central node is further caused to receive a confirmation from the source distributed node indicating successful configuration of the user equipment to operate on the beam of the target distributed node, to cause a bearer configuration with the target distributed node to enable user data transmission over the beam of the target distributed node, and to forward user data for the user equipment to the target distributed node.

According to a further aspect, a source distributed node for inter cell beam management in a radio access network is provided the radio access network includes the source distributed node and a target distributed node. The source distributed node and target distributed node are controlled by a central node of the radio access network. The source distributed node comprises at least one processor and at least one memory including computer program code causing the central node, when executed with the at least one processor, to receive configuration information from the central node related to a beam of a cell of the target distributed node. The source distributed node is then caused to initiate an inter cell beam management operation with the user equipment to enable the user equipment to operate on the beam of the cell of the target distributed node.

In some embodiments, the inter cell beam management operation comprises a low layer mobility procedure or a dynamic cell switching procedure.

In some embodiments, the configuration information includes an inter-cell beam management indication or packet scheduling related information.

In some embodiments, the configuration information indicates a bandwidth part currently used by the user equipment with the source distributed node to be used for the beam of the cell of the target distributed node.

In some embodiments, the source distributed node is further caused to receive a context modification request from the central node requesting inter cell beam management related information about the user equipment and to transmit a context modification response towards the central node indicating inter cell beam management related information about the user terminal which may indicate at least one of timing advance information of the user equipment, bandwidth part information of the user equipment, and a measurement configuration of the user equipment.

In some embodiments, the bandwidth part information of the user equipment indicates multiple bandwidth parts suitable for the communication of the user equipment with the source distributed node and wherein the configuration information includes at least a subset of the multiple bandwidth parts to enable the user equipment to operate any bandwidth part of the subset of the multiple bandwidth parts on the beam of the cell of the target distributed node.

In some embodiments, the source distributed node is further caused to send an indication towards the central node indicating a number of beams or identity of beams which are timing advance aligned with neighboring cells.

In some embodiments, the source distributed node is further caused to send an indication towards the central node to switch a first bandwidth part of the user equipment to a second bandwidth part. The source node may receive an indication from the central node not to use the beam of the cell of the target distributed node. The source distributed node receives an indication from the central node that the beam of the target distributed node is to be reconfigured to the second bandwidth part and indicates the reconfiguration to the second bandwidth part to the user equipment.

In some embodiments, the source distributed node is further causes to send a confirmation towards the central node indicating successful configuration of the user equipment to operate on the beam of the target distributed node.

According to still a further aspect, a non-transitory computer-readable storage medium stores computer program instructions which, when executed by at least one processor, causes a central node of a radio access network to perform any one of the central node related methods set out above.

According to still a further aspect, a non-transitory computer-readable storage medium stores computer program instructions which, when executed by at least one processor, causes a source distributed node of a radio access network to perform any one of the source distributed node related methods set out above.

According to still a further aspect, a computer program comprises instructions which, when executed by at least one processor, causes a central node of a radio access network to perform any one of the central node related methods set out above.

According to still a further aspect, a computer program comprises instructions which, when executed by at least one processor, causes a source distributed node of a radio access network to perform any one of the source distributed node related methods set out above.

### BRIEF DESCRIPTION OF THE DRAWINGS

In the following embodiments will be described in greater detail with reference to the attached drawings, in which:

FIG. 1 shows a schematic diagram of an example communication system comprising a base station and a plurality of communication devices.

FIG. 2 shows a schematic diagram of an example mobile communication device.

FIG. 3 shows a schematic diagram of an example control apparatus.

FIGS. 4A and 4B depict an NG-RAN architecture.

FIG. 5 depicts a network coverage examples in a mobile communication network.

FIG. 6 is a general representation of an inter-cell beam management (ICBM) procedure as described herein.

FIG. 7 shows a more detailed inter-cell beam management (ICBM) procedure with the components of a base station.

FIG. 8 shows the ICBM procedure with bandwidth parts handling.

FIG. 9 shows the ICBM procedure with a plurality of possible bandwidth parts at terminal side.

FIG. 10 depicts the ICBM procedure with various components of the base station.

### DETAILED DESCRIPTION

3GPP Technical Specification 38.300 V17.0.0 , subclause 9.2.3.1 differentiates between cell level mobility and beam level mobility. Cell level mobility requires explicit signalling by way of Radio Resource Control (RRC) in order to make the UE to switch to a new cell. Beam level mobility, on the other hand, does not require explicit RRC signalling. Beam level mobility can be within a cell, or between cells, the latter is referred to as inter-cell beam management (ICBM). For ICBM, a UE can receive or transmit UE dedicated channels/signals via a TRP (Transmit/Receive Point) associated with a physical cell identifier (PCI) different from the PCI of a serving cell, while non-UE-dedicated channels/signals can only be received via a TRP associated with a PCI of the serving cell. The gNB (Next Generation NodeB, 5G base station) provides via RRC signalling the UE with measurement configuration containing configurations of SSB/CSI resources (SSB=Synchronization Signal Block, CSI=Channel State Information) and resource sets, reports and trigger states for triggering channel and interference measurements and reports. In case of ICBM, a measurement configuration includes SSB resources associated with PCIs different from the PCI of a serving cell. Beam Level Mobility is then dealt with at lower layers by means of physical layer and Medium Access Control (MAC) layer control signalling, and RRC is not required to know which beam is being used at a given point in time.

Detailed concepts how to utilize ICBM to promote mobile performance on the one hand, while ensuring connectivity and service continuity on the other hand, are currently missing.

The present disclosure provides mechanisms to extend the lower layer mobility concept of inter-cell beam management (ICBM). Moreover, the present disclosure addresses dynamic switching between different cells of a base station at the layer 1 (L1) level by providing information for different communication messages between the components of the base station and the terminal to initiate the ICBM procedures.

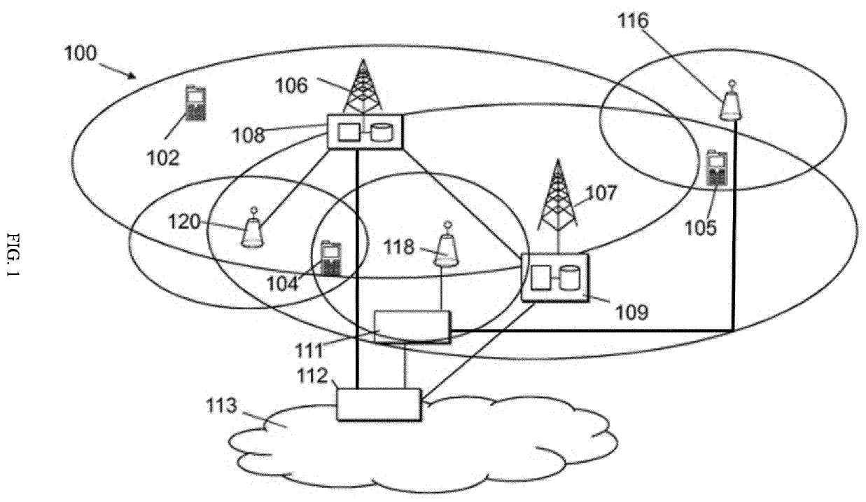

Before explaining the examples in detail, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices, user devices, User Equipment (UE) 102, 104, 105 are provided wireless access via at least one base station (e.g., next generation NB, gNB), similar wireless transmitting and/or receiving node or network node. Base stations may be controlled or assisted by at least one appropriate controller apparatus, so as to enable operation thereof and management of mobile communication devices in communication with the base stations. The controller apparatus may be located in a Radio Access Network (RAN) (e.g., wireless communication system 100) or in a Core Network (CN) (not shown) and may be implemented as one central apparatus or its functionality may be distributed over several apparatuses. The controller apparatus may be part of the base station and/or provided by a separate entity such as a Radio Network Controller (RNC) or central unit (CU), typically implementing higher network layers such as layer 3 protocols and/or a Radio Resource Control (RRC) protocol. In FIG. 1, control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in the RNC.

In FIG. 1, base stations 106 and 107 are shown as connected to a wider communications network 113 via gateway 112. A further gateway function may be provided to connect to another network.

As used herein, the term “base station” has the full breadth of its ordinary meaning, and at least includes a wireless communication station installed at a fixed location and used to communicate as part of a wireless telephone system or radio system. The communication area (or coverage area) of the base stations may be referred to as a “cell.” The base stations and the UEs may be configured to communicate over the transmission medium using any of various Radio Access Technologies (RATs), also referred to as wireless communication technologies, or telecommunication standards described hereinbelow. As illustrated in FIG. 1, while one of the base stations may act as a “serving cell” for UEs, an UE may also be capable of receiving signals from (and possibly within communication range of) one or more other cells (which might be provided by the base stations and/or any other base stations), which may be referred to as “neighboring cells”. As mentioned above, a base station may include multiple network nodes such as a superordinated controller node implementing higher network layers such as layer 3/RRC and one or more subordinated nodes such as distributed units (DUs) typically implementing lower network layers such as the physical layer (layer 1, L1) and layer 2 (L2). Note that these multiple units may be geographically co-located or geographically dislocated to a certain extent.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example, Wireless Local Area Network (WLAN) and may be WLAN Access Points (APs). The communication devices 102, 104, 105 may access the communication system based on various access techniques, such as Code Division Multiple Access (CDMA), or Wideband CDMA (WCDMA). Other non-limiting examples comprise Time Division Multiple Access (TDMA), Frequency Division Multiple Access (FDMA) and various schemes thereof such as the Interleaved Frequency Division Multiple Access (IFDMA), Single Carrier Frequency Division Multiple Access (SC-FDMA) and Orthogonal Frequency Division Multiple Access (OFDMA), Space Division Multiple Access (SDMA) and so on.

An example of wireless communication systems are architectures standardized by the 3rd Generation Partnership Project (3GPP). A latest 3GPP based development is often referred to as the Long-Term Evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE (or LTE-A) employs a radio mobile architecture known as the Evolved Universal Terrestrial Radio Access Network (E-UTRAN) and a Core Network known as the Evolved Packet Core (EPC). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as WLAN and/or Worldwide interoperability for Microwave access (WiMax). A base station can provide coverage for an entire cell or similar radio service area. Core network elements include Mobility Management Entity (MME), Serving Gateway (S-GW) and Packet Gateway (P-GW).

An example of a suitable communications system is the 5G or NR concept. Network architecture in NR may be similar to that of LTE-A. Base stations of NR systems may be known as next generation Node Bs (gNBs). Changes to the network architecture may depend on the need to support various radio technologies and finer Quality of Service (QOS) support, and some on-demand requirements for QoS levels to support Quality of Experience (QoE) of user point of view. Also network aware services and applications, and service and application aware networks may bring changes to the architecture. Those are related to Information Centric Network (ICN) and User-Centric Content Delivery Network (UC-CDN) approaches. NR may use Multiple Input-Multiple Output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilize Network Functions Virtualization (NFV) which is a network architecture concept that proposes virtualizing network node functions into “building blocks” or entities that may be operationally connected or linked together to provide services. A Virtualized Network Function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

An example 5G Core Network (CN) comprises functional entities. The CN is connected to a UE via the Radio Access Network (RAN). A User Plane Function (UPF) whose role is called PDU Session Anchor (PSA) may be responsible for forwarding frames back and forth between the Data Network (DN) and the tunnels established over the 5G towards the UEs exchanging traffic with the DN.

The UPF is controlled by a Session Management Function (SMF) that receives policies from a Policy Control Function (PCF). The CN may also include an Access and Mobility Function (AMF).

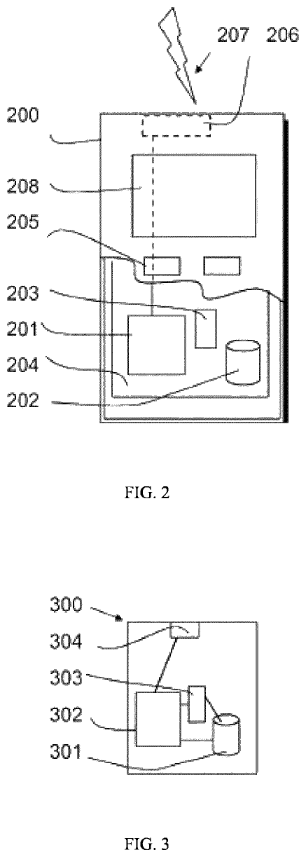

A possible (mobile) communication device 200 will now be described in more detail with reference to FIG. 2 showing a schematic, partially sectioned view. Such a mobile communication device 200 is often referred to as User Equipment (UE), user device or terminal device. An appropriate mobile communication device 200 may be provided by any device capable of sending and receiving radio signals. Non-limiting examples comprise a Mobile Station (MS) or mobile device such as a mobile phone or what is known as a smart phone, a computer provided with a wireless interface card or other wireless interface facility (e.g., USB dongle), Personal Data Assistant (PDA) or a tablet provided with wireless communication capabilities, or any combinations of these or the like. The communication device 200 may provide, for example, communication of data for carrying communications such as voice, electronic mail (e-mail), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

In an industrial application a communication device may be a modem integrated into an industrial actuator (e.g., a robot arm) and/or a modem acting as an Ethernet-hub that will act as a connection point for one or several connected Ethernet devices (which connection may be wired or unwired).

The communication device 200 is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets 204. The user may control the operation of the communication device 200 by means of a suitable user interface such as keypad 205, voice commands, touch sensitive screen or pad, combinations thereof or the like. A display 208, a speaker and a microphone can be also provided. Furthermore, the communication device 200 may comprise appropriate connectors (either wired or wireless) to other devices and/or for connecting external accessories, for example hands-free equipment, thereto.

The communication device 200 may receive signals over an air or radio interface 207 via appropriate apparatus for receiving and may transmit signals via appropriate apparatus for transmitting radio signals. In FIG. 2, transceiver apparatus is designated schematically by block 206. The transceiver apparatus 206 may be provided for example by means of a radio part and associated antenna arrangement. The antenna arrangement may be arranged internally or externally to the communication device 200.

The communication device 200 may also or alternatively be configured to communicate using one or more Global Navigational Satellite Systems (GNSS such as GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

Generally, the communication device 200 illustrated in FIG. 2 includes a set of components configured to perform core functions. For example, this set of components may be implemented as a system on chip (SoC), which may include portions for various purposes. Alternatively, this set of components may be implemented as separate components or groups of components for the various purposes. The set of components may be (communicatively) coupled (e.g., directly or indirectly) to various other circuits of the communication device 200.

The communication device 200 may include at least one antenna in communication with a transmitter and a receiver (e.g., the transceiver apparatus 206). Alternatively, transmit and receive antennas may be separate. The communication device 200 may also include a processor (e.g., the at least one data processing entity 201) configured to provide signals to and receive signals from the transmitter and receiver, respectively, and to control the functioning of the communication device 200. The processor may be configured to control the functioning of the transmitter and receiver by effecting control signaling via electrical leads to the transmitter and receiver. Likewise, the processor may be configured to control other elements of the communication device 200 by effecting control signaling via electrical leads connecting processor to the other elements, such as a display (e.g., display 208) or a memory (e.g., the at least one memory 202). The processor may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an Application Specific Integrated Circuit (ASIC), a Field Programmable Gate Array (FPGA), and/or the like, or some combination thereof. Accordingly, in some examples, the processor may comprise a plurality of processors or processing cores.

The communication device 200 may be capable of operating with one or more air interface standards, communication protocols, modulation types, access types, and/or the like. Signals sent and received by the processor may include signaling information in accordance with an air interface standard of an applicable cellular system, and/or any number of different wireline or wireless networking techniques, comprising but not limited to Wi-Fi, WLAN techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the communication device 200 and/or a cellular modem therein may be capable of operating in accordance with various 3rd Generation (3G) communication protocols, 4th generation (4G) communication protocols, 5^{th} Generation (5G) communication protocols, Internet Protocol Multimedia Subsystem (IMS) communication protocols such as, for example, Session Initiation Protocol (SIP) and/or the like, or 5G beyond. For example, the communication device 200 may be capable of operating in accordance with 4G wireless communication protocols, such as LTE-A, 5G, and/or the like as well as similar wireless communication protocols that may be subsequently developed.

It is understood that the processor may include circuitry for implementing audio/video and logic functions of the communication device 200. For example, the processor may comprise a digital signal processor device, a microprocessor device, an analog-to-digital converter, a digital-to-analog converter, and/or the like. Control and signal processing functions of the communication device 200 may be allocated between these devices according to their respective capabilities. The processor may additionally comprise an internal voice coder, an internal data modem, and/or the like. Further, the processor may include functionality to operate one or more software programs, which may be stored in memory. In general, the processor and stored software instructions may be configured to cause the communication device 200 to perform actions. For example, the processor may be capable of operating a connectivity program, such as a web browser. The connectivity program may allow the communication device 200 to transmit and receive web content, such as location-based content, according to a protocol, such as Wireless Application Protocol (WAP), HyperText Transfer Protocol (HTTP), and/or the like.

The communication device 200 may also comprise a user interface including, for example, an earphone or speaker, a ringer, a microphone, a display, a user input interface, and/or the like, which may be operationally coupled to the processor. The display may, as noted above, include a touch sensitive display, where a user may touch and/or gesture to make selections, enter values, and/or the like. The processor may also include user interface circuitry configured to control at least some functions of one or more elements of the user interface, such as the speaker, the ringer, the microphone, the display, and/or the like. The processor and/or user interface circuitry comprising the processor may be configured to control one or more functions of one or more elements of the user interface through computer program instructions, for example, software and/or firmware, stored on a memory accessible to the processor, for example, volatile memory, non-volatile memory, and/or the like. The communication device 200 may include a battery for powering various circuits related to the mobile terminal, for example, a circuit to provide mechanical vibration as a detectable output. The user input interface may comprise devices allowing the communication device 200 to receive data, such as a keypad (e.g., keypad 206) and/or other input devices. The keypad can also be a virtual keyboard presented on display or an externally coupled keyboard.

The communication device 200 may also include one or more mechanisms for sharing and/or obtaining data. For example, the communication device 200 may include a short-range radio frequency (RF) transceiver and/or interrogator, so data may be shared with and/or obtained from electronic devices in accordance with RF techniques. The communication device 200 may include other short-range transceivers, such as an infrared (IR) transceiver, a Bluetooth™ (BT) transceiver operating using Bluetooth™ wireless technology, a wireless Universal Serial Bus (USB) transceiver, a Bluetooth™ Low Energy transceiver, a ZigBee transceiver, an ANT transceiver, a cellular device-to-device transceiver, a wireless local area link transceiver, and/or any other short-range radio technology. The communication device 200 and more specifically, the short-range transceiver may be capable of transmitting data to and/or receiving data from electronic devices within the proximity of the apparatus, such as within 10 meters, for example. The communication device 200 including the Wi-Fi or WLAN modem may also be capable of transmitting and/or receiving data from electronic devices according to various wireless networking techniques, including 6LoWPAN, Wi-Fi, Wi-Fi low power, WLAN techniques such as IEEE 802.11 techniques, IEEE 802.15 techniques, IEEE 802.16 techniques, and/or the like.

The communication device 200 may comprise memory, such as one or more Subscriber Identity Modules (SIM), one or more Universal Subscriber Identity Modules (USIM), one or more removable User Identity Modules (R-UIM), one or more Embedded Universal Integrated Circuit Cards (eUICCs), one or more Universal Integrated Circuit Cards (UICC), and/or the like, which may store information elements related to a mobile subscriber. In addition, the communication device 200 may include other removable and/or fixed memory. The communication device 200 may include volatile memory and/or non-volatile memory. For example, the volatile memory may include Random Access Memory (RAM) including dynamic and/or static RAM, on-chip or off-chip cache memory, and/or the like. The non-volatile memory, which may be embedded and/or removable, may include, for example, read-only memory, flash memory, magnetic storage devices, for example, hard disks, floppy disk drives, magnetic tape, optical disc drives and/or media, non-volatile random-access memory (NVRAM), and/or the like. Like volatile memory, the non-volatile memory may include a cache area for temporary storage of data. At least part of the volatile and/or non-volatile memory may be embedded in the processor. The memories may store one or more software programs, instructions, pieces of information, data, and/or the like which may be used by the apparatus for performing operations disclosed herein.

The memories may comprise an identifier, such as an International Mobile Equipment Identification (IMEI) code, capable of uniquely identifying the communication device 200. In the example embodiment, the processor may be configured using computer code stored at memory to cause the processor to perform operations disclosed herein.

Some of the embodiments disclosed herein may be implemented in software, hardware, application logic, or a combination of software, hardware, and application logic. The software, application logic, and/or hardware may reside on the memory, the processor, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 2, computer-readable medium may comprise a non-transitory computer-readable storage medium that may be any media that can contain or store the instructions for use by or in connection with an instruction execution system, apparatus, or device, such as a computer.

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio towards a RAN (e.g. to reach and communicate with a serving cell). A UE may generate and transmit and receive RRC messages containing one or more RRC PDUs (Packet Data Units).

The UE may have different states (e.g. according to 3GPP TS 38.331 V16.5.0 (2021 -06) sections 42.1 and 4.4, incorporated by reference). A UE is e.g. either in RRC CONNECTED state or in RRC INACTIVE state when an RRC connection has been established.

In RRC_CONNECTED state a UE may store the AS (access stratum) context, transfer unicast data to/from the UE, monitor control channels associated with the shared data channel to determine if data is scheduled for the data channel, provide channel quality and feedback information, perform neighboring cell measurements and measurement reporting.

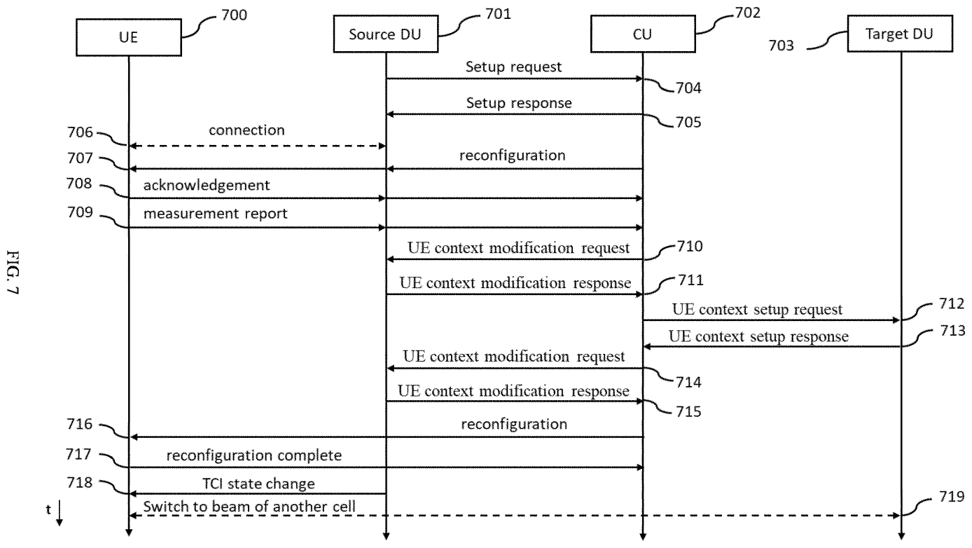

In some embodiments, the communication device 200 (i.e., UE or a user device in a network) comprises the processor (e.g., the at least one data processing entity 201) and the memory (e.g., the at least one memory 202). The memory includes computer program code causing the communication device 200 to perform processing according to the methods described below with reference to FIG. 6.

FIG. 3 shows an example embodiment of a control apparatus for a communication system, for example to be coupled to and/or for controlling a station of an access system, such as a RAN node, e.g., a base station, eNB or gNB, a relay node or a core network node such as an MME or S-GW or P-GW, or a core network function such as AMF/SMF, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as an RNC or a spectrum controller. In some embodiments, an base station may have such a control apparatus as well as a control apparatus being provided in an RNC. The control apparatus 300 can be arranged to provide control on communications in the service area of the system. The control apparatus 300 comprises at least one memory 301, at least one data processing unit 302, 303 and an input/output interface 304. Via the interface the control apparatus 300 can be coupled to a receiver and a transmitter of the base station. The receiver and/or the transmitter may be implemented as a radio front end or a remote radio head.

Generally, the control apparatus 300 has an antenna, which transmits and receives radio signals. A radio frequency (RF) transceiver module, coupled with the antenna, receives RF signals from antenna, converts them to baseband signals and sends them to processor (e.g., the at least one data processing unit 302, 303). RF transceiver also converts received baseband signals from processor, converts them to RF signals, and sends out to antenna. A processor processes the received baseband signals and invokes different functional modules to perform features in control apparatus 300. Memory (e.g., the at least one memory 301) stores program instructions and data to control the operations of the control apparatus 300. In the example of FIG. 3, the control apparatus 300 also includes protocol stack and a set of control functional modules and circuit. PDU session handling circuit handles PDU session establishment and modification procedures. Policy control module that configures policy rules for UEs. Configuration and control circuit provides different parameters to configure and control UEs of related functionalities including mobility management and session management. Suitable processors include, by way of example, a special purpose processor, a digital signal processor (DSP), a plurality of micro-processors, one or more micro-processor associated with a DSP core, a controller, a microcontroller, ASICs, FPGA circuits, and other type of integrated circuits (ICs), and/or state machines.

In some embodiments, the control apparatus 300 (i.e., a base station, a wireless transmitting and/or receiving point equipment, or a network node in a network) comprises the processor (e.g., the at least one data processing unit 302, 303) and the memory (e.g., the at least one memory 301). The memory includes computer program code causing the control apparatus 300 to perform processing according to the method described below with reference to FIG. 6.

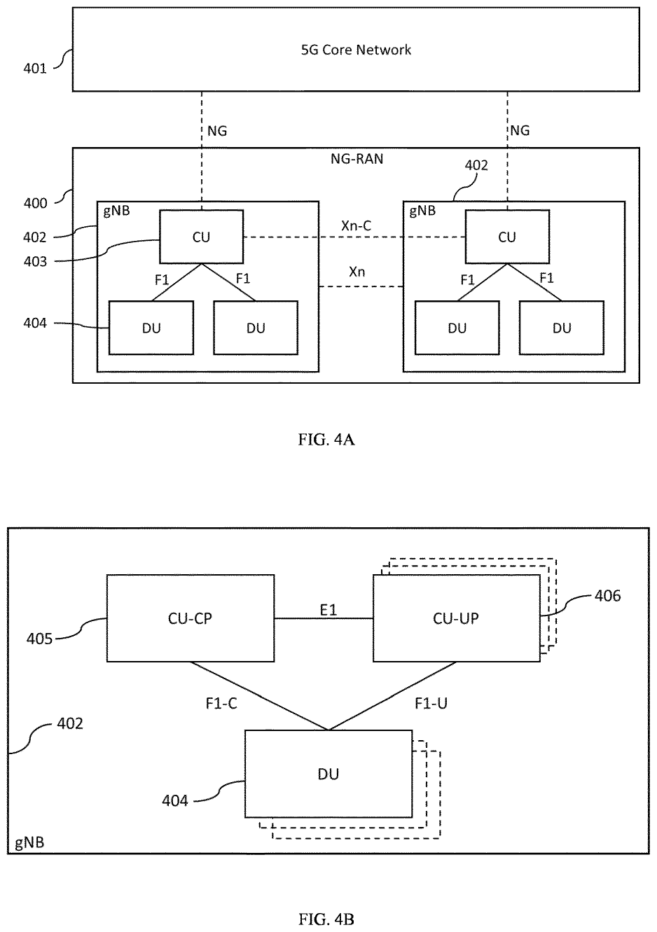

FIGS. 4A and 4B depict a next-generation radio access network (NG-RAN) architecture 400 with gNBs 402 according to 3 GPP TS38.401 v16.9.0 . A gNB 402 employs NR user/control plane protocols to serve UEs and is connected to the 5GC 401 via the logical NG interface and to other gNBs 402 through Xn interface to support the exchange of signaling information and forwarding PDUs. The gNB 402 of FIG. 4A comprises a central unit (i.e., CU) 403 and one or more distributed units (i.e., DU) 404. The CU is a logical node hosting RRC, SDAP and PDCP protocols of the gNB or RRC and PDCP protocols of the gNB that controls the operation of one or more DUs 404. The CU 403 terminates the F1 interface connected with the DUs 404 subordinate to the CU 403. The DU 404 is a logical node hosting RLC, MAC and PHY layers of the gNB 402, and its operation is partly controlled by CU 403. One DU 404 supports one or multiple cells. One cell is supported by one DU 404. The DU 404 terminates the F1 interface connected with the CU 403.

One DU 404 is connected to one CU 403 via F1 interface. NG, Xn, and F1 are logical interfaces. The Xn-C interface interconnects CUs 403 of different gNBs 402. The gNB 402 can also comprise a CU control-plane (CU-CP), multiple CU user-plane (CU-UPs), and multiple DUs, which are depicted in more detail in FIG. 4B.

It should be noted that NG-RAN could also comprise a set of ng-eNBs, an ng-eNB may comprise an ng-eNB-CU and one or more ng-eNB-DU(s). During initial transition and deployment phase of 5G NR (New Radio), 4G networks are available everywhere. There will be many localities where there will not be 5G coverage and only coverage available will be using 4G LTE network. In such locations, ng-eNBs allow 5G subscribers to connect using the 4G air interface with 5G NG-core to avail 5G services. An ng-eNB-CU and an ng-eNB-DU is connected via W1 interface.

FIG. 4B illustrates the architecture with separation of the control plane and the user plane for the gNB-CU (i.e., CU-CP and CU-UP) 403. The CU-CP 405 is a logical node hosting the RRC and the control plane part of the PDCP protocol of the CU 403 for a gNB 402. The CU-CP 405 terminates the E1 interface connected with the CU-UP 406 and the F1-C interface connected with the DU 404. The CU-UP 406 is a logical node hosting the user plane part of the PDCP protocol of the CU 403 for a gNB, and the user plane part of the PDCP protocol and the SDAP protocol of the CU 403 for a gNB 402. The CU-UP 406 terminates the E1 interface connected with the CU-CP 405 and the F1-U interface connected with the DU 404, e.g. according to 3GPP TS 38.401 V16.6.0 (2021 -07) section 3.1 incorporated by reference. The CU-UP 406 is connected to one CU-CP 405, to multiple CU-UPs 406 and multiple DUs 404 under the control of the same CU-CP 405.

In some embodiments, the CU-CP 405 comprises or is associated to a processor and a memory. The memory includes computer program code causing the CU-CP 405 to perform processing according to the method described below with reference to FIG. 6.

Different functional splits between the central and distributed unit are possible, e.g. called options:
Option 1 (1A-like split): The function split in this option is similar to the 1A architecture in DC (dual connectivity). RRC is in the central unit (CU). PDCP, RLC, MAC, physical layer and RF are in the distributed unit (DU).
Option 2 (3C-like split): The function split in this option is similar to the 3C architecture in DC. RRC and PDCP are in the central unit. RLC, MAC, physical layer and RF are in the distributed unit.
Option 3 (intra RLC split): Low RLC (partial function of RLC), MAC, physical layer and RF are in the distributed unit. PDCP and high RLC (the other partial function of RLC) are in the central unit.
Option 4 (RLC-MAC split): MAC, physical layer and RF are in the distributed unit. PDCP and RLC are in the central unit.

Further functional splits are also envisaged, e.g. according to 3GPP TR 38.801 V 14.0.0 (2017-03) section 11 incorporated by reference.

As mentioned above, a base station such as a gNB supports different protocol layers, e.g. Layer 1 (L1)-physical layer. The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g. the physical layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers, the SDAP sublayer offers to 5GC QoS flows, control channels include BCCH (Broadcast Control Channel), and PCCH (Paging Control Channel).

Layer 3 (L3) includes e.g. Radio Resource Control (RRC) at the control plane, e.g. according to 3GPP TS 38.300 V16.6.0(2021 -06) section 6 incorporated by reference. The RRC protocol includes e.g. the following main functions: RRC connection control, measurement configuration and reporting, establishment/modification/release of measurement configuration (e.g. intra-frequency, inter-frequency and inter-RAT measurements), setup and release of measurement gaps, measurement reporting.

A RAN (Radio Access Network) node or network node like e.g. a gNB, base station, gNB CU or gNB DU or parts thereof may be implemented using e.g. an apparatus with at least one processor and/or at least one memory (with computer-readable instructions/computer program) configured to support and/or provision and/or process CU and/or DU related functionality and/or features, and/or at least one protocol (sub-)layer of a RAN (Radio Access Network), e.g. layer 2 and/or layer 3. They may also be implemented using specific means configured to perform respective specific tasks, e.g. layer 3 means to perform layer 3 operations, layer 2 means to perform layer 2 operations, etc. A central node may e.g. implement CU-CP and/or CP-UP functionality.

The gNB CU and gNB DU parts may e.g. be co-located or physically separated. The gNB DU may even be split further, e.g. into two parts, e.g. one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof.

A gNB-DU supports one or multiple cells, and could thus serve as e.g. a serving cell for a user equipment (UE).

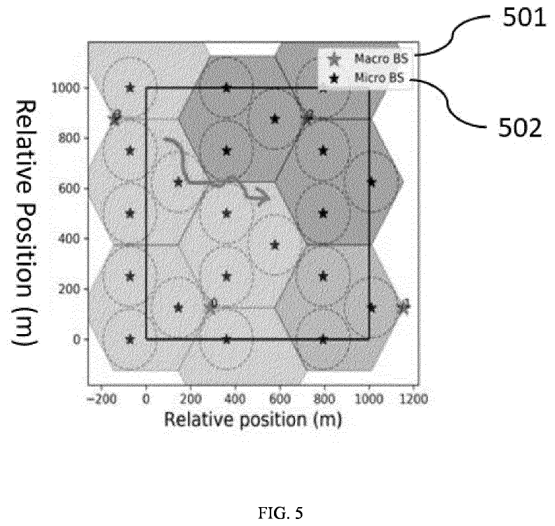

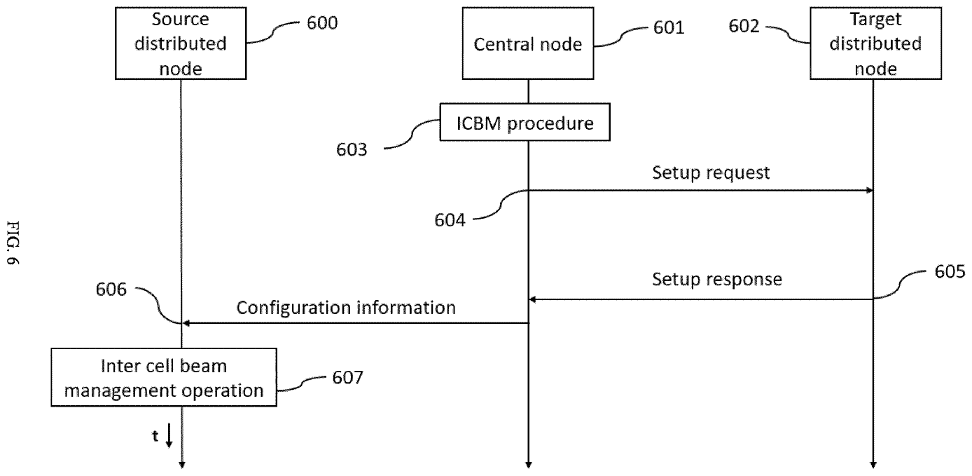

FIG. 5 illustrates an exemplary use case for ICBM procedure with a mobile terminal (UE) moving through an exemplary network topology. A typical cell topology of a radio access networks (RAN) like e.g. a 5G RAN is realized by base stations (gNBs), while a gNB may be composed of several sub-elements such as a CU and multiple DUs, as already explained above. FIG. 5 represents a DU by way of a hexagon which includes three cells (labelled as micro BS 502 and small star) and a macro BS 501 is represented by a bigger star in the middle of three Hexagons

When a UE moves through the RAN infrastructure, e.g. as visualized by the trail of the arrow in FIG. 5, it may be possible that the UE travels through different cells which may lead to several handovers. The number of back-and-forth handovers should be kept low, e.g., as each handover procedure introduces signaling overhead including signaling messages exchanged over the radio path between the UE and the RAN. Note that the topology shown by FIG. 5 is typically more complex in practice, as due to “shadowing, buildings, etc.” the coverage might be more diverse in reality with “radio gaps” in a cells, where a neighboring cell may provide better coverage. The more realistic “real world example” may lead to even more ping-pongs, e.g., as cell coverage islands exist and if the UE travels through or close to these islands. This may even be more and more the case if more and more (narrow) beams are used (e.g., in millimeter wave radio connections scenarios).

The present disclosure seeks to provide instruments for improving such mobility situations in 5G and beyond systems. Generally, the present disclosure encompasses switching to and/or temporarily adding a beam of a further network element than the currently serving network element for the UE in order to enhance radio coverage, while keeping radio level signaling and procedural complexity low. More specifically, the present disclosure encompasses switching to and/or temporarily adding a beam of a distributed unit (DU), hereinafter also denoted as target distributed node, than the currently serving distributed unit, hereinafter also denoted as source distributed node, both distributed nodes being controlled by a central unit (CU). To this end, the present disclosure provides an extension of inter-cell beam management (ICBM) procedures.

With reference to FIG. 6, some general aspects of the ICBM procedure are illustrated. These general aspects can be described by referring to at least three elements, namely central node (CU, 601), the source distributed node (also referred to as serving DU, 600) and the target distributed node (target DU, 602). The distributed nodes 600, 602 support distributed unit functionality, the layer 1 protocol or the layer 2 protocol stack of the radio access network. The central node 601 supports at least central unit control plane functionality or a layer 3 protocol of the radio access network. The central node 601 controls the source distributed node 600 and the target distributed node 602. The overall procedure can be presented from the perspective of any one of these network nodes. Optionally, the procedure can also be described from the perspective of the user equipment.

The UE is communicatively coupled with the source distributed node 600. For example, the UE is in state RRC_CONNECTED and exchanging user plane data over the radio interface with the source distributed node (and the central node 601 and core network elements at higher layers). As some point, at 603, the central node 601 determines to initiate an inter cell beam management procedure for the UE currently being served by the source distributed node 600. As explained further below, the determination 603 may be based on measurements for beams of neighboring cells for which the UE has been previously configured and according to which the UE transmits measurement reports indicating current radio channel conditions to the network, in particular to the central node 602, on a regular basis. The central node 601 then, at 604, transmits a setup request to the target distributed node 602 in order to configure a beam of a cell of the target distributed node 602 for the UE. In embodiments, the setup request 604 is a UE Context Setup Request carrying a number of information elements (IE) such as an IE indicating that the UE Context Setup Request is part of an ICBM procedure, an IE with timing advance information, an IE indicating the beam of the target distributed node 602 to be configured for the UE, as well as recent measurements of the UE for the beam, an IE including packet scheduling information (e.g., physical channel information details such as Physical Downlink Shared Channel, PDSCH, configuration), and so on. Optionally, bandwidth part (BWP) information may be added in order to configure the beam of the target distributed node 602 on a bandwidth part currently used by the UE.

Accordingly, the target distributed node 602 receives the setup request 604, checks whether the setup request 604 can be positively answered and, if so, returns a setup response 605 to the central node 601. Accordingly, the central node 601 receives the setup response 605 from the target distributed node 602. The setup response 605 carries user equipment specific beam management configuration information related to the requested beam of the cell of the target distributed node. This configuration information 606 or at least a part of the configuration information that is relevant for the UE to switch to or add the beam of the cell of the target distributed node is then transmitted by the central node 601 towards the source distributed node 600. Accordingly, the source distributed node 600 receives the configuration information 607 related to the beam of a cell of the target distributed node 602. By way of the configuration information 606, the source distributed node 600 is enabled to initiate an inter cell beam management operation with the UE dynamically, fast and efficient with little overhead at any given time, e.g. depending on current radio conditions reported by the UE on lower layers.

The inter cell beam management operation is, for example, a low layer mobility procedure. Low layer mobility (LLM) is the procedure of executing a cell change with MAC layer indications. The MAC layer indications are determined to be sent to the UE using L1 measurements sent by the UE. For example, a TCI (Transmission Configuration Indicator) state change indication provides a TCI dynamically to the UE in a DCI message. A TCI can refer to a higher layer (e.g. RRC) configuration or reconfiguration which provides the beam management configuration for the UE to switch to or add the beam of the cell of the target distributed node. The inter cell beam management operation may also include a dynamic cell switching procedure. Dynamic cell switching is the procedure of consecutive execution of multiple LLM procedures without any re-preparation. The preparation here refers to provisioning of the UE with target cell configurations. The target cell configuration is maintained at the UE and can be re-used after a cell change.

The procedure of FIG. 6 enables the source distributed node 600 and the central node 601, respectively, to trigger ICBM with cells provided by the target distributed node 602, respectively, that is different than the source distributed node 600. This allows the UE to utilize the ICBM operation to enjoy additional radio resources of cells provided by a target DU spanning a different cell than the cell in which the UE is currently located in. This effectively extends the coverage of ICBM operation to broader use-cases. Due to the ICBM procedure employed, the procedure encompasses little overhead and is therefore efficient.

Note that the ICBM procedure described herein may cause a switch of the data connection and control connection of the user equipment with the source distributed node (source DU) to the beam of the target distributed node (target DU), i.e. a serving cell change is effected. Alternatively, the ICBM procedure may switch the data connection to the beam of the cell of the target distributed node (target DU), but may keep the control connection with the serving cell of the source distributed node (source DU). In this way, the UE can dynamically switch the data connection back and forth (more specifically, the current source DU can make the UE switch the data connection back and forth) between different DUs, while the control connection is maintained with the serving cell of the source distributed node.

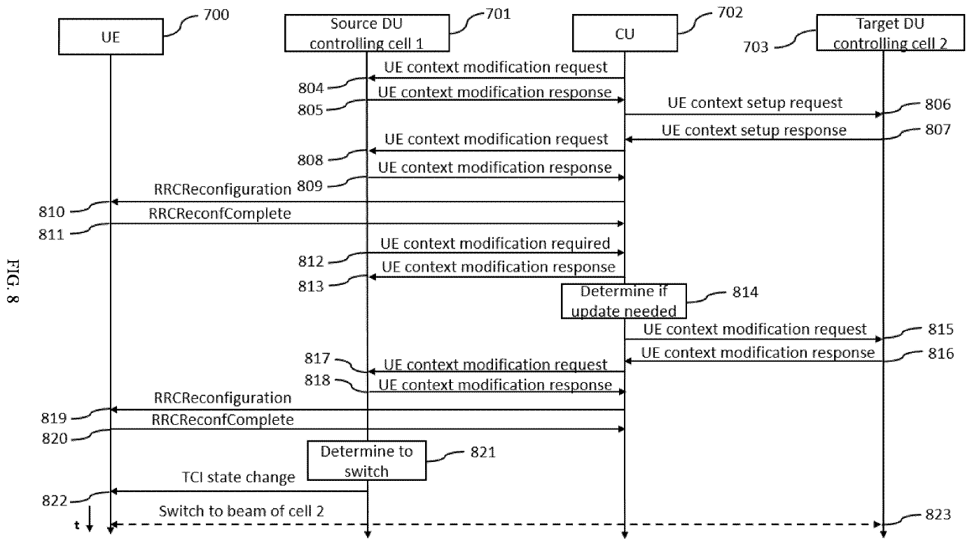

Some embodiments as depicted in FIG. 7 include further messages and additional detail of the ICBM procedures described herein. The ICBM configuration is setup at the target DU 703 based on the UE measurements. For this, the UE 700 performs, in response to receiving a measurement configuration message from the source DU 701, measurements of at least the beam of the cell of the target DU 703. The UE 700 then reports a set of best neighbor beams so the CU 702 can determine potential targets for any later ICBM operation. Therefore, the UE 700 transmits, to the source DU 701, at least one measurement report indicating results of the measurements of the at least one beam of the cell of the target DU 703.

More specifically, a preparation phase of the ICBM procedure of FIG. 7 includes activities 704-709, starting with an F1 setup request, at 704, where the source DU 701 indicates to CU 702 the list of ICBM suitable beams that are timing advance (TA) aligned with the neighbor cells. This information can be configured to the source DU 701, or the source DU 701 obtains this information with respect to operation and maintenance.

Next, at 705, the CU 702 sends a F1 setup response confirming the F1 setup request. An alternative implementation uses a DU configuration update procedure including a configuration update request and a configuration update response message.

Now, at 706, the UE 700 has established a connection to a cell of the source DU 701, which now acts as a serving DU 701. Followed by that, at 707, the CU 702 configures the UE 700 to perform measurements of the beam of the cell of the target DU 703 (and typically other beams provided by the target DU 703 or any other DUs controlled by the CU 702) which may be indicated in the RRCReconfiguration message 707. As a consequence, the UE 700, at 708, acknowledges the configuration with RRCReconfigurationComplete message and starts sending measurement reports, at 709. The measurement reports may be already filtered and aggregated, so a Level 3 (L3) data set with measurement results for the beam of the neighbor cell (target DU 703) to the source DU 701 and the further to the CU 702. Hence, the CU 702 receives at least one measurement report from the UE 700 indicating results of the measurements of at least the beam of the cell of the target DU 703.

At 710, the CU 702 determines to initiate the ICBM procedure in order to switch the UE 700 to the beam of the cell of the target DU 703. This ICBM decision is based on the measurement reports provided by the UE 700 beforehand, which may indicate that the beam in the cell of the target DU 703 provides substantially better radio conditions than the current beam of the UE 700 utilized in the cell of the source DU 701. To this end, the CU 702 sends and the source DU 701 receives a context modification request requesting inter-cell beam management related information about the UE to facilitate the ICBM procedure. In embodiments, this requested ICBM related information may include the timing advance information or the possible bandwidth parts or the measurement configuration of the UE 700. The UE 700 may also be configured with two timing advance loops to control the timing advance for different cells or the UE 700 may be configured to report the DL sync difference between the source cell and the target cell, that may be used to detect the alignment at the UE side.

The source DU 701 returns, to the CU, a context modification response 711 indicating the requested ICBM related information, such as timing advance information of the UE, bandwidth part information of the UE, and a measurement configuration of the UE. The source DU 701 may also indicate a number of beams and/or identities of beams which are timing advance (TA) aligned with neighboring cells in case the CU 702 aims to initiate the ICBM procedure for a beam, e.g. beam A of cell 2, where the UE 700 has the same TA. Note that, for a micro cell with zero timing advance, this activity may be skipped and does not take place. The information of a micro-cell with zero timing advance is configured to the CU 702.

At 712, the CU 702 sends the setup request (cf. also FIG. 6) such as a UE context setup request to the target DU 703 including an ICBM indication and packet scheduling related information (e.g., PDSCH config) with the beam management configuration related to the target cell 2 for the UE 700 e.g., beam A of cell 2 should be used for ICBM. Besides, the UE context setup request also provides at least a part of the results of the measurements in the setup request to the target distributed node.

The following UE context setup response 713 (cf. FIG. 6), from the target DU 703 provides static beam information to the source DU 701 through CU 702. With that, the source DU 701 can use this information to add this to the UE beam management configuration and inform the CU 702 afterwards. The target DU 703 incorporates the beam configuration of the target cell, in the beam management configuration of the UE 700, or alternatively, the beam configuration of the target cell is provided in a container to be included in the beam management configuration by the source DU 701.

At 714, the CU 702 indicates the acquired beam configuration from the target DU 703 to the source DU 701 with another UE context modification request. The source DU 701 may incorporate the beam configuration into the beam management configuration of the UE 700 if the alternative is used. Otherwise, at 715, the source DU 701 may take notice of the beam configuration of the target cell to be able to switch the UE 700 to the beam of the target DU 703 with a following UE context modification response.

Next, at 716, the CU 702 provides the UE 700 with the ICBM configuration e.g. by way an RRCReconfiguration message which includes beam information for, e.g. beam A of cell 2, whereby, at 717. The UE 700 acknowledges the reconfiguration with the RRCReconfigurationComplete message. After that, at 718, the source DU 701 may initiate the inter cell beam management operation by sending a signal such as a transmission configuration indication (TCI), to switch the UE 700 to beam A of cell 2 of the target DU 703. Alternatively, in embodiments, beam A of cell 2 of the target DU 703 is added, resulting in a dual connectivity type scenario that will last for a short amount of time that is cumbersome for network to establish and de-configure afterwards. This further ICBM decision, now taken locally at the source DU 701, utilizes the preparation occurred beforehand, in particular the provision of the beam related configuration to the UE 700 with the RRCReconfiguration 716. The TCI state change is an efficient procedure incorporating little overhead as the reference to the RRC configuration to switch to the beam of the target DU 703 can e.g. be included in the DCI (downlink control information) transmitted to the UE. The ICBM decision of the source DU 701 may be based on current LI measurement reports such as CSI (channel state information).

Finally, at 719, the UE 700 and the target DU 703 start operating on the newly configured beam A of cell 2 provided by the target DU 703.

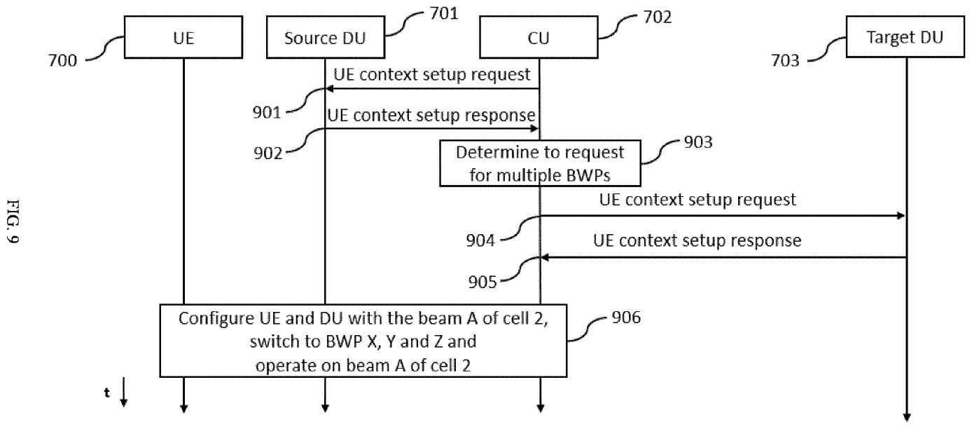

In some embodiments, now with reference to FIG. 8, the ICBM procedure may also include the handling of bandwidth parts (BWP). To further illustrate the individual stages of the ICBM initiation, it is presumed that the UE is connected to cell 1 of the source DU 701 prior to the execution of the ICBM procedure.

In such embodiments, the CU 702 indicates with a UE context modification request 804 that the CU 702 aims to initiate the ICBM procedure and requests ICBM related information from the source DU 701. With the ICBM related information, the source DU 701 indicates, at 805, with a UE context modification response the serving BWP e.g., X, of the UE.

Next, at 806, the CU 702 indicates to the target DU 703, that the CU 702 aims to initiate the ICBM procedure and forwards the BWP information of the UE 700 with a UE context setup request including an indication of a bandwidth part (e.g. BWP X) currently utilized by the UE 700. The target DU 703 arranges the beam information on the BWP of the UE 700 by e.g., checking whether it is possible to use beam A for serving the UE 700 in BWP X, because in some inter-cell interference coordination schemes the activation of some beams might be limited over a specific part of the bandwidth. The target DU 703 indicates, at 807, with a UE context setup response this information to the CU 702, that the beam of the target DU 703 is to be configured on the first bandwidth part e.g., beam A of cell 2 operates in BWP X. Now, the CU 702 is aware of the BWP of the beam A of cell 2, so that the CU 702 may determine if a change of the BWP of the UE 700 is needed.

Further, at 808, the CU 702 indicates with another UE context modification request the beam information provided by the target DU 703 to the source DU 701. The source DU 701 may then incorporate this information in the UE context and provide the information back to the CU 702 with another UE context modification request 809.

Next, at 810, the CU 702 reconfigures the UE with the new beam information of beam A from cell 2 with BWP X of the target DU 703 through the RRCReconfiguration. The UE 700 sends, at 811, the RRCReconfigurationComplete back to the CU 702 to acknowledge the configuration.

At 812, the source DU 701 determines to switch the BWP X of the UE 700 to another BWP (e.g. Y), so the source DU 701 requests a UE context modification. So, the CU 702 receives, from the source DU 701, an indication of switching a first bandwidth part (e.g. BWP X) currently utilized by the terminal to a second bandwidth part (e.g. BWP Y). The reason for the switch of the BWP can be e.g., due to energy saving purposes and therefore the UE 700 is switched to a narrowed bandwidth so that the UE consumes less energy as the UE 700 monitors in a narrowed bandwidth. Moreover, the BWP switch may be done for load balancing reasons. In this case, the UE 700 can be moved to a bandwidth that is less loaded so that it is easier to maintain UEs in separate BWPs for the cell. Additionally, the BWP switch can be indicated to the CU 702 taking into account the UE capabilities typically classified by a UE category and current BWP configuration situation. If the UE is a Category 1 UE, then the UE typically cannot be configured with more than 1 BWP. If, however, the UE is a Category 2+ UE, and the UE is already configured with 4 BWPs, but the source DU 701 prepares to switch the UE to another BWP than the already configured 4 BWPs. In both cases, the BWP switch is indicated to the CU 702. The UE context modification response 813 of the source DU 701 indicates the BWP switch from X to Y to the CU 702. The CU 702 acknowledges the change and indicates that the beam A of cell 2 of the target DU 703 cannot be used with the current configuration in BWP X.

Next, at 814, the CU 702 determines that the information (BWP X of beam A of cell 2) provided by the target DU 703 from the UE context setup response 807 does not match the new BWP Y of the UE and a BWP update is to be requested. As a consequence, the CU 702 transmits, to the target DU 703, a modification request indicating the second bandwidth part e.g., the CU 702 indicates with another UE context modification request 815 the new BWP Y to the target DU 703, so that the target DU 703 can update the BWP X of beam A of cell 2. Then, the target DU 703 indicates with another corresponding UE context modification response 816 back to the CU 702, that the update of the BWP for beam A was successful i.e., beam A is now configured on BWP Y. So, the CU 702 receives, from the target DU 703, a modification response confirming that the beam of the target DU 703 is reconfigured to the second bandwidth part, e.g., BWP Y.

At 817, the CU 702 indicates, to the source DU 701, that the beam of the target DU 703 is to be reconfigured to the second bandwidth part and the source DU 701 incorporates this beam information of the target DU 703 into the UE context, i.e. beam A of cell 2 on BWP Y can be used now. After that, at 818, the source DU 701 indicates this information to the CU 702 with the UE context modification response. The source DU 701, uses this updated beam configuration as an indication that the UE is configured with the second BWP.

In the next activity, at 819, the UE 700 is configured through the RRCReconfiguration message again, but with the beam A of cell 2 of the target DU 703 in the second BWP Y. As a consequence, the UE 700 acknowledges this configuration with the RRCReconfigurationComplete message 820 to the CU 702.

After that, at 821, the source DU 701 may determine to switch the UE 700 to the beam A of cell 2, due to connectivity problems or local effects that may have a negative impact on the radio channel between the UE 700 and the source DU 701. If the source DU 701 has determined to switch the beam, at 821, then the source DU 701 may send lower layer signal such as a TCI state change message 822 (using a MAC CE based indication, or DCI indicating a TCI state activated using a MAC CE including additional information such as PCI ID). Finally, at 823, the UE 700 switches to or adds the beam A of cell 2 to the list of active beams and operates accordingly.

Embodiments of the sort of FIG. 8 enable the CU 702 to update the beam configuration related to ICBM in case of a bandwidth part change at the UE. The CU 702 is made aware of the BWP configuration of the target cell for ICBM, which enables the CU 702 to request an update to this configuration if the UE is moved to another BWP in the course of the ICBM preparation phase. This provides more reliability for the ICBM operation across BWP switches.

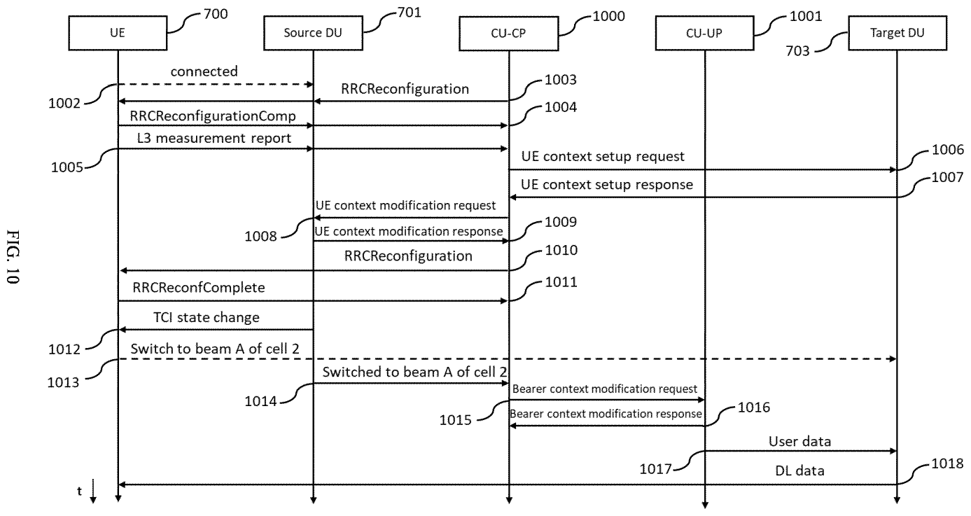

In some embodiments as depicted by FIG. 9, the ICBM procedure can consider multiple possible BWPs on the UE side from the outset. Likewise, as in the procedure of FIG. 8, the UE 700 is connected to cell 1 of the source DU 701 prior to the execution of any ICBM procedure.

The procedure of FIG. 9 starts, at 901, with the CU 702, which indicates in a UE context setup request or, alternatively, a UE context modification request, that the CU 702 aims to initiate the ICBM procedure and requests ICBM related information from the source DU 701 such as multiple BWPs suitable for the communication of the UE 700 with the source DU 701. With the ICBM related information, the source DU 702 indicates the serving BWP e.g., X, of the UE, at 902, with a UE context setup response and additionally the source DU 701 indicates a list with multiple BWPs e.g., Y and Z, suitable for the communication between the UE 700 and the target DU 703 to the CU 702. This may be applicable if the UE 700 is of Category 2+ supports configuration with more than one BWP.

Now, at 903, the CU 702 may determine to request the beam of the target DU 703 on possible BWPs. This decision can be based on signaling optimization, which means not to update the beam A of cell 2 each time a BWP is switched during the ICBM preparation phase or it can be based on the cost of resource reservation at the target DU 703.

At 904, the CU 702 may indicate in a UE context setup request a list of requested BWPs (for X, Y and Z) to the target DU 703. After that, at 905, the target DU 703 prepares the beam of cell 2 on the multiple BWPs (X, Y and Z) and indicates this back to the CU 703 with the UE context setup response 905.

Lastly, at 906, the UE 700 and the source DU 701 are configured with the beam A of cell 2 on multiple BWPs, under the condition that the target DU 703 supports the BWPs of the UE 700. The configuration information includes the subset of the multiple bandwidth parts to enable the UE 700 to operate any bandwidth part of the subset of the multiple bandwidth parts on the at least one beam of the cell of the target DU 703. Then, no update is needed if the UE 700 is switched to another BWP. Now, the UE 700 is ready to operate on beam A of cell 2 of the target DU 703 when the source DU 701 decides to initiate the lower layer cell change procedure such as signaling a TCI state change.

Embodiments of the sort of the procedure of FIG. 9 additionally equip the CU 702 with knowledge of possible BWPs so that the source DU 701 can configure the UE. This enables the CU 702 to request specific BWPs from the target DU 703 accordingly. This can decrease signaling load at F1 interface, as preparing the beam switch or beam addition with suitable BWPs may reduce re-configurations (such as BWP reconfiguration discussed above with reference to FIG. 8) during the time before the actual beam switch by way of the lower layer cell change procedure.

In some embodiments, now with reference to FIG. 10, the ICBM procedure is defined at a further level granularity such as the central node 702 incorporating a CU control plane, CU-CP 1000, and a CU user plane, CU-UP 1001. In such embodiments, the ICBM procedure initiation generally corresponds to the process of FIG. 7, but additionally includes further process activities between the CU-UP 1001 of the target DU and the target DU 703.

Starting at 706 again, the UE 700 is connected to the source DU 701 and operates normally with cell 1 prior to any ICBM procedure.

Similar to FIG. 7, the CU-CP 1000 reconfigures the UE 700 with the RRCReconfiguration message 1003 to report measurements of the beams of a neighbor cell controlled by target DU 703. The UE acknowledges the reconfiguration with the RRCReconfigurationComp message 1004 and starts sending measurements of the beam of the neighbor cell afterwards. The L3 measurement, i.e. filtered beam measurements which are TA aligned, permanently available or have a sufficient range, report 1005 including the beam information of beam A of cell 2 is transmitted back to the CU-CP as a result of the reconfiguration.

Now, the CU-CP 1000 sends a UE context setup request 1006 to the target DU 703 and indicates to start the ICBM procedure including the beam management and packet scheduling (e.g., PDSCH config) related information again. The target DU 703 incorporates the beam configuration of the target cell 2 and responds with the corresponding UE context setup response including in the beam management configuration of the UE 700 or the target DU sends the beam management configuration in a container as described further above.

The following activities 1008 to 1013 correspond to the activities 714 to 719 of FIG. 7, except that the CU 702 is replaced with the CU-CP 1000. Therefore, in the following the usage of the CU-UP 1001 in the ICBM procedure is briefly discussed.

After the UE 700 is configured with the beam A of cell 2 and can switch to or, alternatively, “borrow” (temporarily assign) the beam of the target DU 703, the source DU receives a confirmation from the UE 700 indicating successful configuration of the UE 700 to operate on the at least one beam of the target DU 703, i.e. the UE 700 uses beam A of cell 2 of the target DU 703. Then, the source DU 701 indicates the new configuration by sending a response to the CU-CP 1000 at 1014.

Next, the CU-CP 1000 causes a bearer establishment or modification to enable user data transmission over the at least one beam of the target DU 703 by sending a bearer modification request 1015 to the target CU-UP 1001. Right after that, the CU-UP 1000 is sending a bearer modification response 1016 to acknowledge the bearer. Finally, the CU-UP 1001 can use this information for the required bearer modification of the target DU 703 and can start forwarding user data for the terminal to the target DU 703, at 1017, through beam A of cell 2. In this way, the UE 700 has now access to a fully configured beam of another cell of a corresponding other DU to use in ICBM procedure to avoid handovers when it is not necessary at all. The UE 700 is now capable of transmitting and/or receiving user data, at 1018, over the beam A of cell 2 of the target DU 703.

It should be understood that the apparatuses described herein may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE and 5G NR, similar principles can be applied in relation to other networks and communication systems where enforcing fast connection re-establishment is required. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes exemplary embodiments, there are several variations and modifications which may be made to the disclosed solution without departing from the scope of the subject disclosure.

In general, the various exemplary embodiments may be implemented in hardware or special purpose circuits, software, logic or any combination thereof. Some aspects of the subject disclosure may be implemented in hardware, while other aspects may be implemented in firmware or software which may be executed by a controller, microprocessor or other computing device, although the subject disclosure is not limited thereto. While various aspects of the subject disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Example embodiments of the subject disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASICs), FPGA, gate level circuits and processors based on multi-core processor architecture, as non-limiting examples.

Example embodiments of the subject disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of the subject disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of the subject disclosure as defined in the appended claims. Indeed, there is a further embodiment comprising a combination of one or more embodiments with any of the other embodiments previously discussed.

1-50. (canceled)

51. A central node for inter cell beam management in a radio access network comprising a source distributed node and a target distributed node, the source distributed node and target distributed node being controlled by the central node of the radio access network, the central node comprising at least one processor and at least one memory including computer program code causing the central node, when executed with the at least one processor, to:
in response to determining to initiate an inter cell beam management procedure for a user equipment being served by the source distributed node, transmit, towards the target distributed node, a setup request to configure a beam of a cell of the target distributed node for the user equipment;
receive, from the target distributed node, a setup response with user equipment specific beam management configuration information related to the requested beam of the cell of the target distributed node;
transmit, towards the source distributed node, at least a part of the configuration information to enable the source distributed unit to initiate an inter cell beam management operation with the user equipment to enable the user equipment to operate on the beam of the cell of the target distributed node.

52. The central node of claim 51, wherein the inter cell beam management operation comprises a low layer mobility procedure or a dynamic cell switching procedure.

53. The central node of claim 51, wherein the setup request includes an inter-cell beam management indication and/or packet scheduling related information.

54. The central node of claim 51, wherein the setup request includes an indication of a bandwidth part currently utilized by the user equipment and the setup response includes an indication that the beam of the cell of the target distributed node is to be configured on the first bandwidth part.

55. The central node of claim 51, further being caused to:
send, towards the source distributed node, a context modification request requesting inter cell beam management related information about the user equipment;
receive, from the source distributed node, a context modification response indicating inter cell beam management related information about the user equipment.

56. The central node of claim 55, wherein the inter cell beam management related information indicates at least one of timing advance information of the user equipment, bandwidth part information of the user equipment, and a measurement configuration of the user equipment.

57. The central node of claim 51, further being caused to:
configure the user equipment, to perform measurements at least of the beam of the cell of the target distributed node; and
receive, from the user equipment, at least one measurement report indicating results of the measurements of at least the beam of the cell of the target distributed node.

58. The central node of claim 57, further being caused to:
provide at least a part of the results of the measurements in the setup request to the target distributed node.

59. The central node of claim 51, further being caused to:
receive, from the source distributed node, an indication of a number of beams and/or identity of beams which are timing advance aligned with neighboring cells.

60. The central node of claim 51, further being caused to:
determine a bandwidth part switch for the user equipment changing the user equipment from a first bandwidth part to a second bandwidth part;
transmit, towards the target distributed node, an indication of the bandwidth part switch for the user equipment;
receive, from the target distributed node, a confirmation that the beam of the cell of the target distributed node is reconfigured in accordance with the bandwidth part switch for the user equipment; and
reconfigure the user equipment with the second bandwidth part.

61. The central node of claim 60, further being caused to:
receive, from the source distributed node, an indication of switching the first bandwidth part of the user equipment to the second bandwidth part;
indicate, towards the source distributed node, not to use the beam of the cell of the target distributed node;
transmit, towards the target distributed node, a modification request indicating the second bandwidth part;
receive, from the target distributed node, a modification response confirming that the beam of the target distributed node is reconfigured to the second bandwidth part; and
indicate, towards the source distributed node, that the beam of the cell of the target distributed node is to be reconfigured to the second bandwidth part.

62. The central node of claim 51, wherein the setup request indicates multiple bandwidth parts suitable for the communication of the user equipment with the source distributed node and the setup response indicates at least a subset of the multiple bandwidth parts which is suitable for the beam of the cell of the target distributed node, and wherein the configuration information includes the subset of the multiple bandwidth parts to enable the user equipment to operate on any bandwidth part of the subset of the multiple bandwidth parts on the beam of the cell of the target distributed node.

63. The central node of claim 51, further being caused to:
receive a confirmation from the source distributed node indicating successful configuration of the user equipment to operate on the beam of the target distributed node;
cause, with the target distributed node, a bearer configuration to enable user data transmission over the beam of the target distributed node; and
forward user data for the user equipment to the target distributed node.

64. A source distributed node for inter cell beam management in a radio access network including the source distributed node and a target distributed node, the source distributed node and target distributed node being controlled by a central node of the radio access network, the source distributed node comprising at least one processor and at least one memory including computer program code causing the source distributed node, when executed with the at least one processor, to:
receive, from the central node, configuration information related to a beam of a cell of the target distributed node;
initiate an inter cell beam management operation with a user equipment to enable the user equipment to operate on the beam of the cell of the target distributed node.

65. The source distributed node of claim 64, wherein the inter cell beam management operation comprises a low layer mobility procedure or a dynamic cell switching procedure.

66. The source distributed node of claim 64, wherein the configuration information includes an inter-cell beam management indication and/or packet scheduling related information.

67. The source distributed node of claim 64, wherein the configuration information indicates a bandwidth part currently used by the user equipment with the source distributed node to be used for the beam of the cell of the target distributed node.

68. The source distributed node of claim 64, further causing the source distributed node to:
receive, from the central node, a context modification request requesting inter cell beam management related information about the user equipment;
transmit, towards the central node, a context modification response indicating inter cell beam management related information about the user equipment.

69. The source distributed node of claim 68, wherein the inter cell beam management related information indicates at least one of timing advance information of the user equipment, bandwidth part information of the user equipment, and a measurement configuration of the user equipment.

70. The source distributed node of claim 69, wherein the bandwidth part information of the user equipment indicates multiple bandwidth parts suitable for the communication of the user equipment with the source distributed node and wherein the configuration information includes at least a subset of the multiple bandwidth parts to enable the user equipment to operate on any bandwidth part of the subset of the multiple bandwidth parts on the beam of the cell of the target distributed node.

71. The source distributed node of claim 64, further causing the source distributed node to:
send, towards the central node, an indication of a number of beams and/or identity of beams which are timing advance aligned with neighboring cells.

72. The source distributed node of claim 64, further causing the source distributed node to:
send, towards the central node, an indication of switching a first bandwidth part of the user equipment to a second bandwidth part;
receive, from the central node, an indication not to use the beam of the cell of the target distributed node;
receive, from the central node, an indication that the beam of the target distributed node is to be reconfigured to the second bandwidth part;
indicate the reconfiguration to the second bandwidth part to the user equipment.

73. The source distributed node of claim 64, further causing the source distributed node to:
send, towards the central node, a confirmation indicating successful configuration of the user equipment to operate on the beam of the target distributed node to enable the central node to forward user data for the user equipment to the target node.
